(19) United States
(12) Patent Application Publication
(10) Pub. No.: US 2003/0169911 A1
(43) Pub. Date: Sep. 11, 2003

(54) Method and apparatus for processing and displaying images of the arteries and veins

(76) Inventors: Gregory B. Snyder, St. Louis Park, MN (US); Gaurav Kumar, Delhi (IN); Kevin M. Williams, St. Louis Park, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/316,965

(22) Filed: Dec. 11, 2002

Related U.S. Application Data
(60) Provisional application No. 60/339,261, filed on Dec. 11, 2001.

(51) Int. Cl. G06F 17/00

(52) U.S. Cl. 382/130; 128/922

(57) ABSTRACT

A method, system and program for imaging the arterial system provides for obtaining arterial phase image data of a body part with a contrast agent in the arterial vessels but substantially not in the venous vessels. Also obtained is venous phase image data of the body part with the contrast agent in both the arterial vessels and the venous vessels. Arterial image data and venous image data is isolated from the arterial phase image data and/or the venous phase image data. One or both of the isolated arterial image data and the isolated venous image data is altered to produce altered arterial image data and/or altered venous image data. Images derived from the altered arterial image data and or altered venous image data are displayed superimposed on one another.

### RELATED APPLICATION

This application claims priority to U.S. Provisional Application Serial No. 60/339,261, filed Dec. 11, 2001, which is incorporated herein by reference.

### TECHNICAL FIELD OF THE INVENTION

This invention relates generally to diagnostic imaging systems and method, and more particularly to a system for imaging veins and arteries of an animal body.

### BACKGROUND OF THE INVENTION

Diagnostic images of the human vascular system are useful for many medical diagnoses and surgical procedures. Since the vascular system is comprised of soft tissue, the contrast required to obtain useful images is obtained by administering a contrast agent into a patient's blood stream and acquiring, for example, magnetic resonance angiography (MRA) or computed tomographic angiography (CTA) images while the contrast agent is coursing through the patient's vascular system. When administered, the contrast agent first enters the patient's arteries and travels through the arterial system, making it possible to isolate the arteries in images taken at this first point in time, for example about 10 seconds after the contrast agent is administered. The contrast agent eventually makes its way into the venous side, at which time the agent is in both the arterial and venous sides. Any image acquired at this point in time shows both the arteries and the veins. This can make it difficult to readily differentiate between the arteries and veins in such images, particularly where the arteries and veins are proximate or intertwined with one another. Also, the contrast on the venous side is never as bright as when it was a relatively organized bolus on the arterial side.

### SUMMARY OF THE INVENTION

The present invention provides systems and methods, including computer programs, for obtaining and displaying images of the vascular system in which more varied views and images of the arteries and veins are achieved.

### BRIEF DESCRIPTION OF THE DRAWING

FIGS. 1A, 1B, 1C, 1D, 2A, 2B, 3A, 3B, 4A, 4B, 5A, 5B, 5C illustrate example embodiments of images produced by the methods according to the present invention.

FIG. 6 illustrates example embodiments of computer programs according to the present invention.

FIG. 7 illustrates example embodiments of an imaging system according to the present invention.

### DETAILED DESCRIPTION OF THE INVENTION

In the following detailed description of the preferred embodiments, reference is made to the accompanying drawings, which form a part hereof, and in which is shown by way of illustration specific preferred embodiments in which the invention may be practiced. These embodiments are described in sufficient detail to enable those skilled in the art to practice the invention, and it is to be understood hat other embodiments may be utilized and that changes may be made without departing from the spirit and scope of the present invention. The following detailed description is, therefore, not to be taken in a limiting sense, and the scope of the present invention is defined only by the appended claims.

### Method Embodiments

According to a first example embodiment of the invention, there is provided a method for displaying images of the arterial system. In this method, the following operations are performed:

1) Baseline phase image data is obtained for a body part without contrast agent.

2) Arterial phase image data is obtained for a body part with a contrast agent in the arterial vessels but substantially not in the venous vessels approximately ten (10) seconds after acquisition of the baseline phase image data.

3) Venous phase image data is obtained for the body part with the contrast agent in both the arterial vessels and the venous vessels, approximately twenty (20) seconds after acquisition of the baseline data.

4) Arterial image data is isolated by subtracting the baseline phase image data from the arterial image data.

5) Venous image data is isolated from the venous phase image data by subtracting the arterial phase image data from the venous phase image data.

6) Optionally, one or both of the isolated arterial image data and the isolated venous image data is altered to produce altered arterial image data and/or altered venous image data, for example by altering contrast or opacity of the isolated image data.

7) Optionally, images derived from the altered arterial image data and/or altered venous image data, in one example embodiment, are displayed superimposed on one another.

According to one example implementation of this method, the isolated arterial image data or the isolated venous image data is altered by adjusting the opacity or brightness of the image. Or, the altering of one or both of the image data is performed while the derived images are displayed. Alternatively, the method provides for alternately displaying only one of the derived images at a time instead of displaying the derived images superimposed on each other. In another variation, the isolated arterial image data or the isolated venous image data are altered so that the corresponding arteries and veins are displayed in one or more different colors, for example red and blue, respectively.

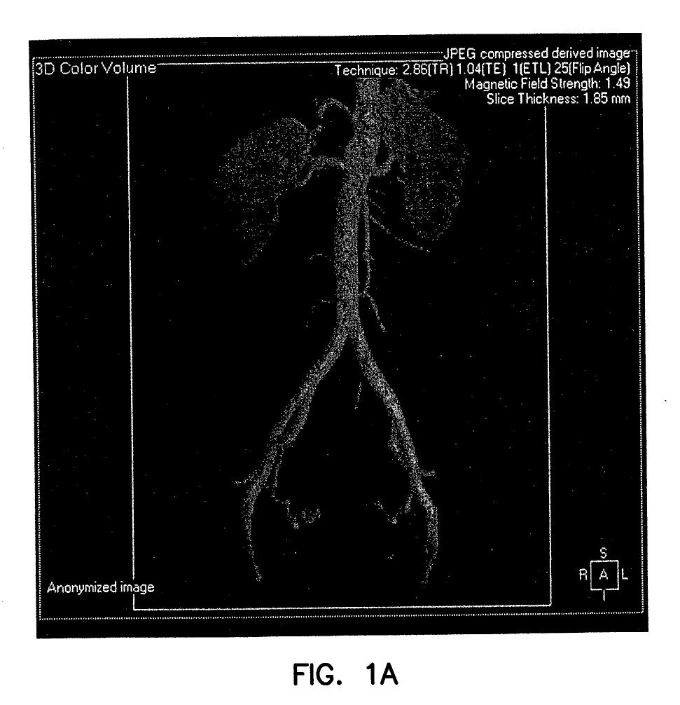

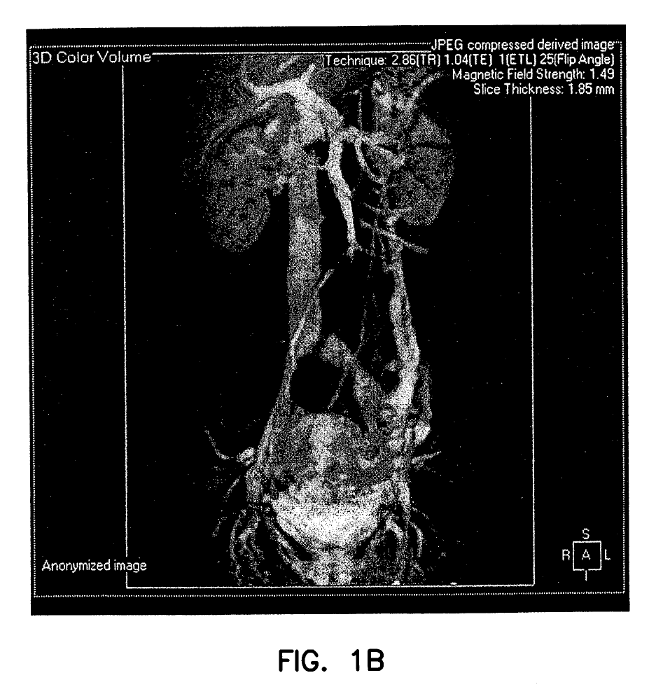

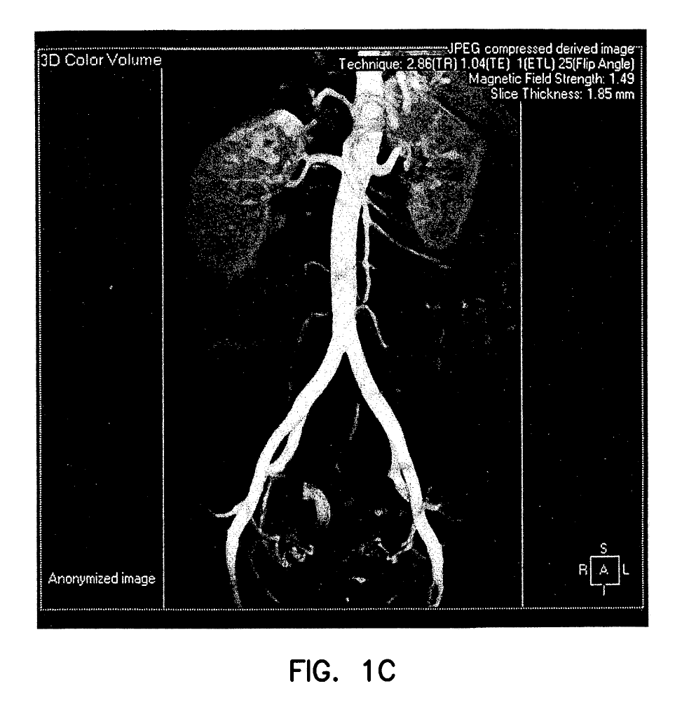

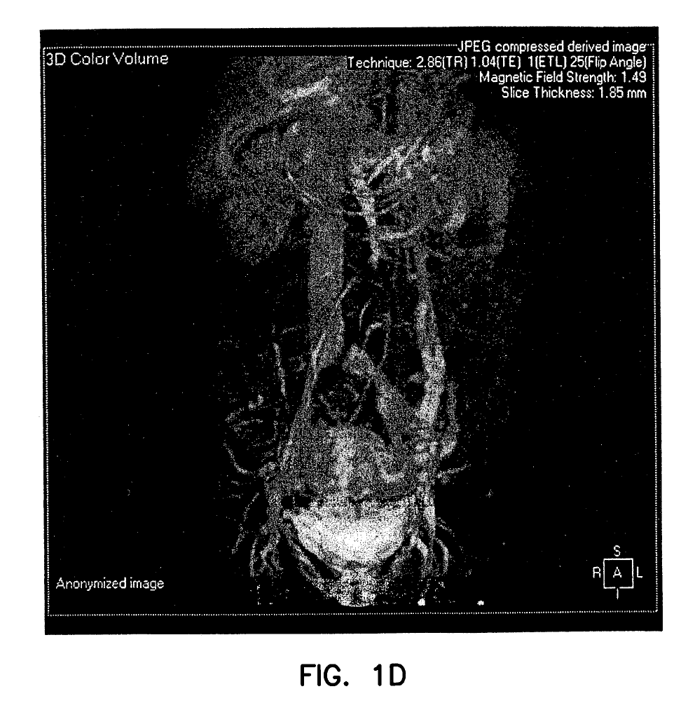

Referring now to FIGS. 1A and 1B, there is illustrated isolated arterial image data and isolated venous image data obtained by operation of the method of the invention described above. The images depict the body region including the kidneys and pelvic area. FIGS. 1C illustrates the arterial image data at a time slightly later than that of the image illustrated in FIG. 1A, and FIG. 1D illustrates the venous image data at a time slightly later than that of the image illustrated in FIG. 1B.

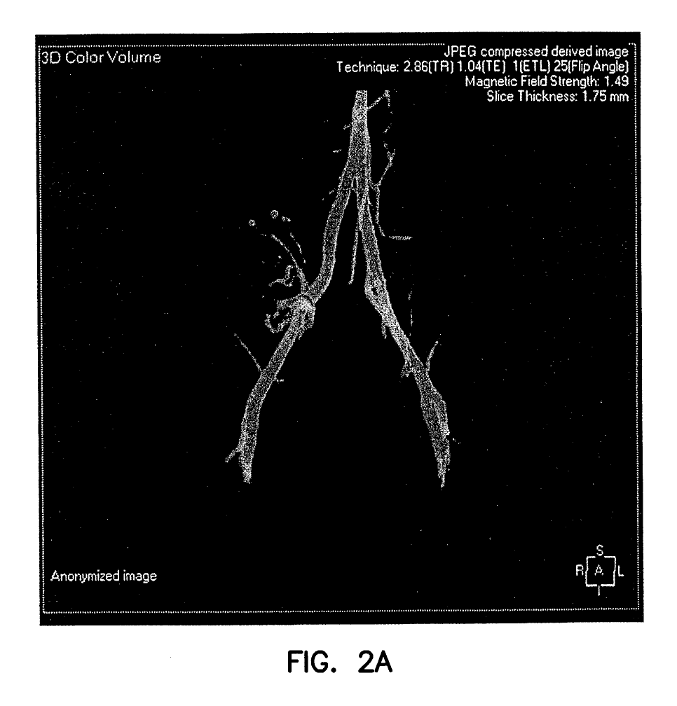

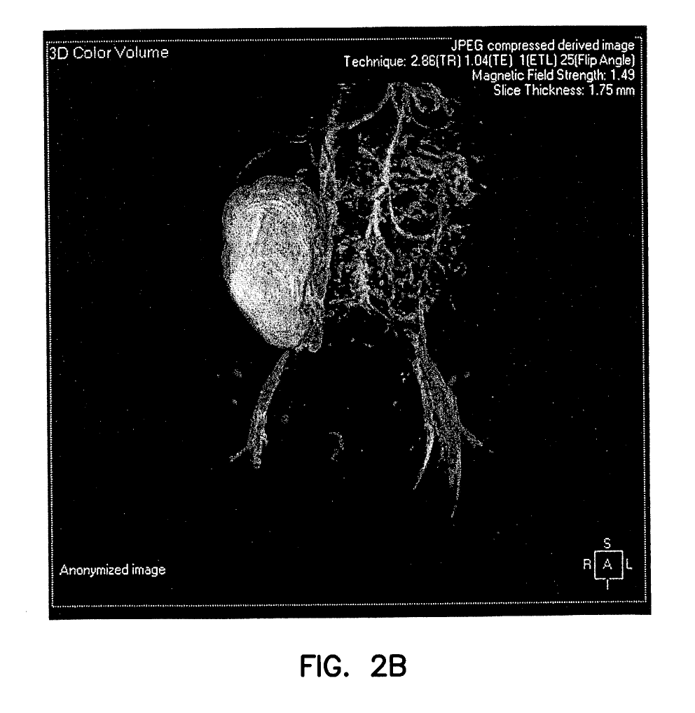

Referring now to FIGS. 2A and 2B, there is illustrated isolated arterial image data and isolated venous image data obtained by operation of the method of the invention described above. The images depict the body region including the kidneys and pelvic area. FIG. 2C illustrates a venous image at a later instance in time than the image of FIG. 2B, showing the flow of blood through the system over time.

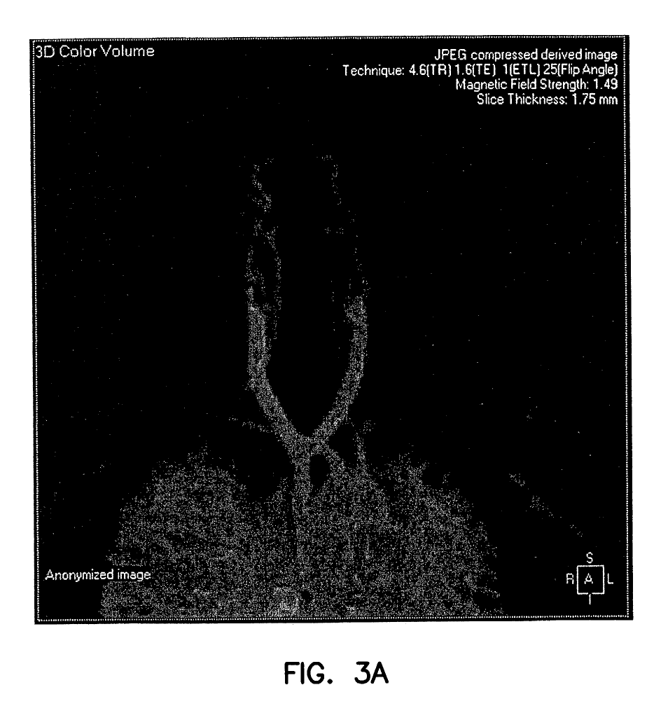

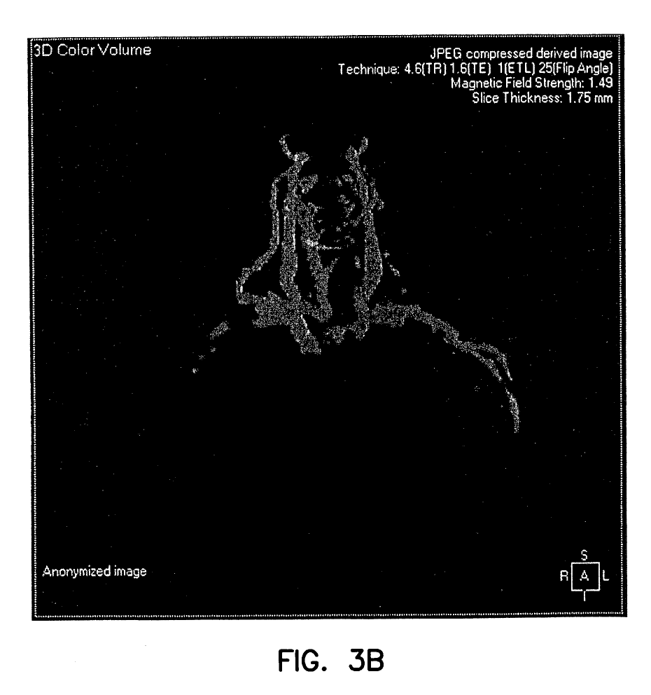

Referring now to FIGS. 3A and 3B, there is illustrated isolated arterial image data and isolated venous image data obtained by operation of the method of the invention described above. The images depict the head and neck region of a body.

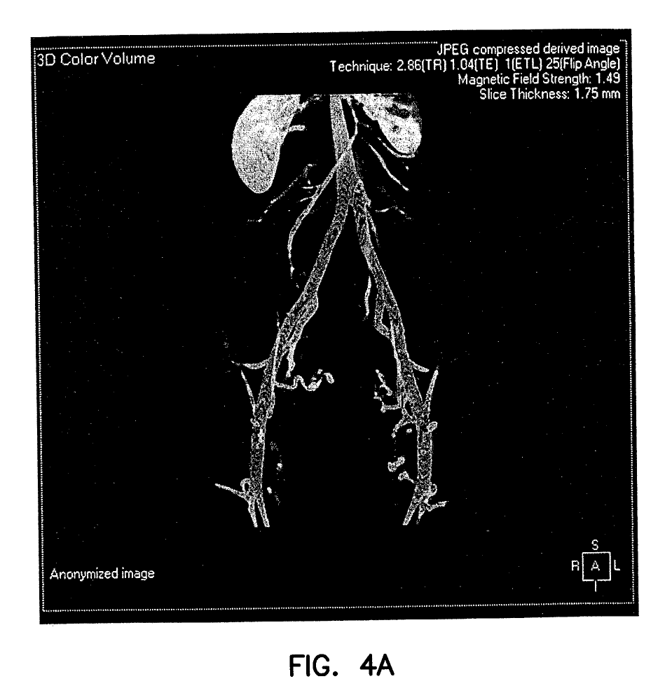

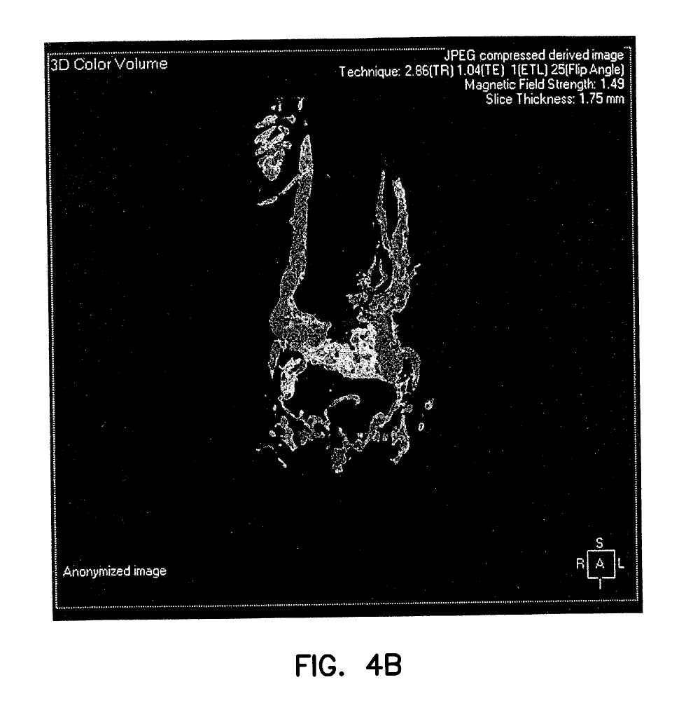

Referring now to FIGS. 4A and 4B, there is illustrated isolated arterial image data and isolated venous image data obtained by operation of the method of the invention described above. The images depict the body region including the kidneys and pelvic area. FIG. 4B illustrates both venous and arterial blood flow in the pelvic area, with the arterial flow represented in red, and the venous flow represented in blue.

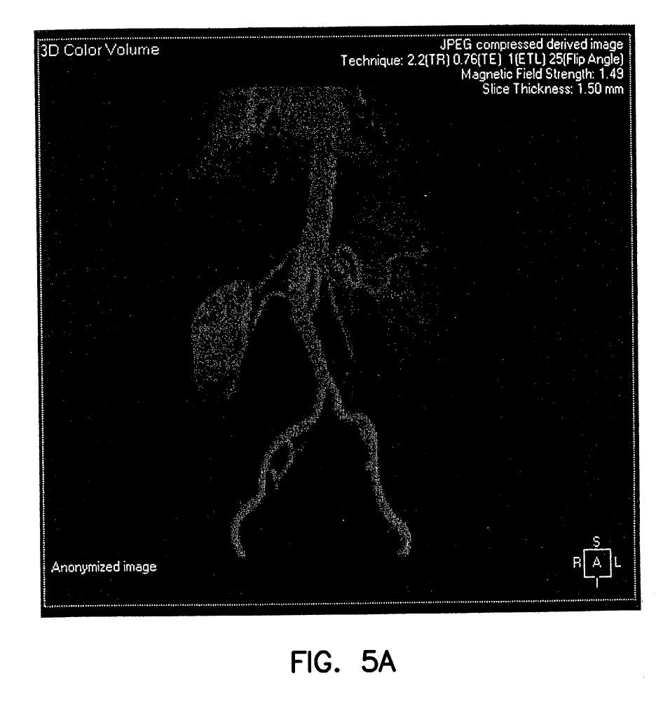

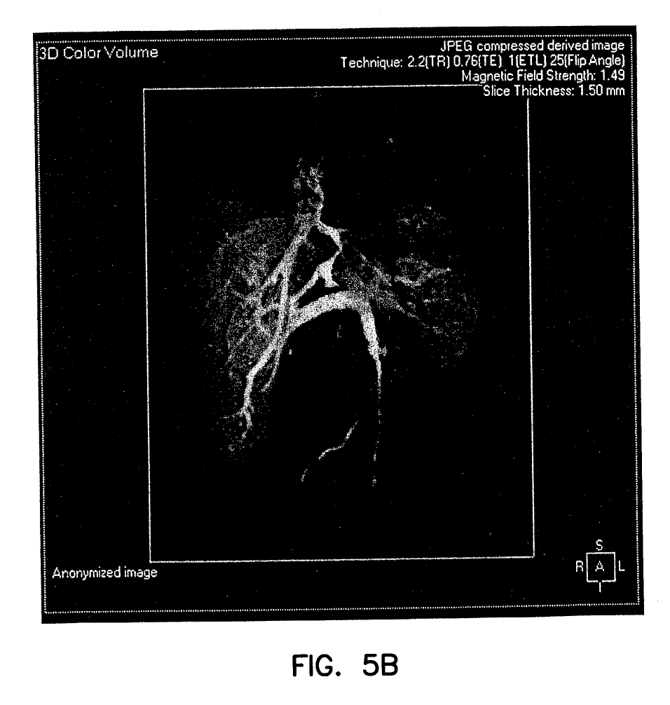

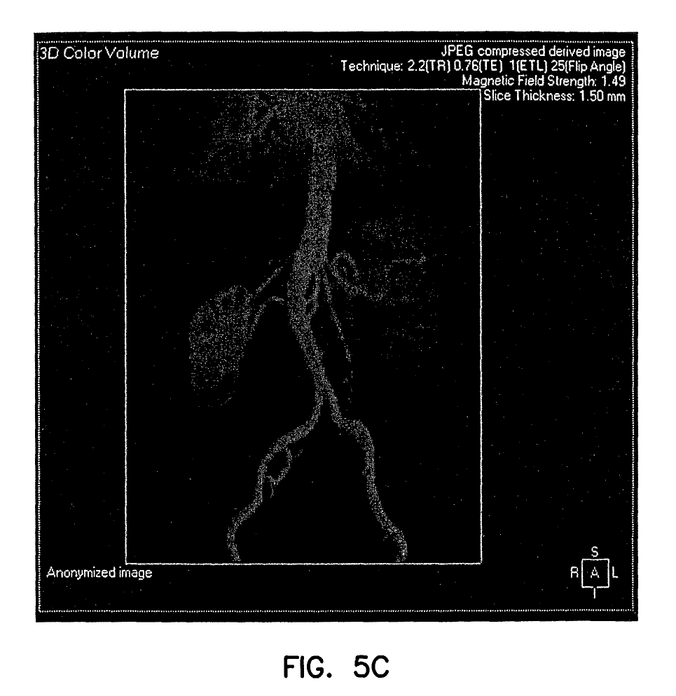

Referring now to FIGS. 5A, 5B and 5C, there is illustrated isolated arterial image data and isolated venous image data obtained by operation of the method of the invention described above. The images depict the body region including the kidneys and pelvic area. FIG. 5B illustrates both venous and arterial blood flow in a kidney, with the arterial flow represented in red, and the venous flow represented in blue.

According to yet another example embodiment, there is provided a method wherein:

1) One or more sets of arterial phase image data are obtained for a body part with a contrast agent in the arterial vessels but substantially not in the venous vessels.

2) One or more sets of venous phase image data are obtained for the body part with the contrast agent in both the arterial vessels and the venous vessels.

3) Arterial image data and venous image data are isolated from the one or more sets of arterial phase image data and/or the venous phase image data.

4) One or both of the isolated arterial image data sets and the isolated venous image data sets are altered to produce altered arterial image data and/or altered venous image data sets wherein each set in the sequence of acquired data sets is altered so that the color of each sequential image is different.

5) Images derived from the altered arterial image or venous image data sets are displayed in a sequence to illustrate blood flow.

According to this example embodiment, different colors assigned to each data set provides that the flow through an organ can be seen temporally, with the blood changing color as flow progressed through the organ. This provides that comparative evaluations of the rate of flow are intuitive.

### Computer Program Embodiments

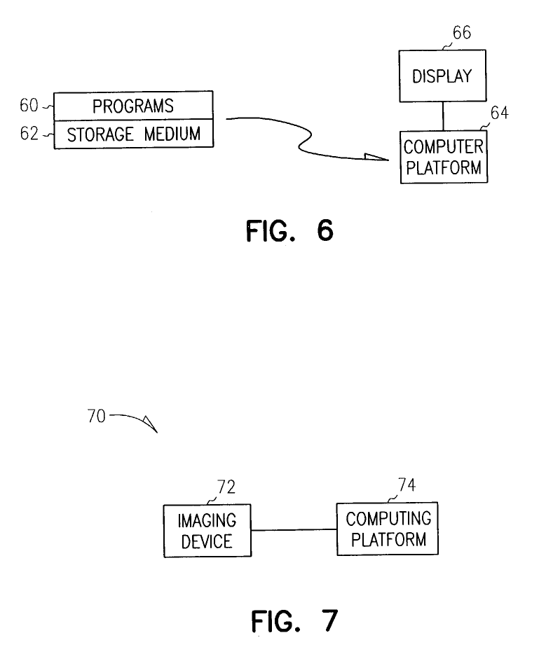

According to yet more example embodiments of the invention, there are provided computer programs for processing image data. As illustrated in FIG. 6, these programs 60 may be stored on or in a physical storage medium 62, execute on a computer platform 64 that includes a display device 66, and carry out the processes of the methods described above.

According to first example embodiment, computer programs 60 includes computer code for storing and retrieving baseline phase image data, arterial phase image data and venous phase image data, wherein the arterial phase image data is obtained from a body part with a contrast agent in the arterial vessels but substantially not in the venous vessels, and the venous phase image data is obtained from a body part with the contrast agent in both the arterial vessels and the venous vessels. The program further includes computer code for isolating arterial image data and venous image data from the arterial phase image data and/or the venous phase image data. Also included is computer code for altering one or both of the isolated arterial image data and the isolated venous image data to produce altered arterial image data and/or altered venous image data. Additionally, there is provided computer code for displaying images derived from the altered arterial image data and or altered venous image data superimposed on one another.

According to yet further example embodiments of programs 60, there is provided computer code for altering the isolated arterial image data or the isolated venous image data by adjusting the opacity of the image, or for altering the isolated arterial image data or the isolated venous image data by adjusting the brightness of the image. Alternatively, there is provided computer code for altering of one or both of the image data is performed while the derived images are displayed, or for alternately displaying only one of the derived images at a time instead of displaying the derived images superimposed on each other.

In still other example embodiments of programs 60, there is provided computer code for altering the isolated arterial image data or the isolated venous image data so that the corresponding arteries and veins are displayed in one or more different colors, such as the arteries red and the veins blue.

In yet another example embodiment of programs 60, there is provided computer code for storing and retrieving baseline phase image data of a body part of a patient without a contrast agent in the vessels. Additionally, there is provided computer code for producing isolated arterial image data by subtracting baseline phase image data from the arterial phase image data, and computer code for producing isolated venous image data by subtracting arterial phase image data from the venous phase image data.

According to still another example embodiment of the invention, there is provided computer programs 60 including computer code for storing and retrieving one or more sets of arterial phase image data of the body part with a contrast agent in the arterial vessels but substantially not in the venous vessels, and for storing and retrieving one or more sets of venous phase image data of the body part with the contrast agent in both the arterial vessels and the venous vessels. The program further includes computer code for isolating arterial image data and venous image data from the one or more sets of arterial phase image data and/or the venous phase image data, and for altering one or both of the isolated arterial image data sets and the isolated venous image data sets to produce altered arterial image data and/or altered venous image data sets wherein each set in the sequence of acquired data sets is altered so that the color of each sequential image is different. Additionally, the programs 60 includes computer code for displaying images derived from the altered arterial image or venous image data sets in a sequence to illustrate blood flow.

### System Embodiments

In still another example embodiment, there is shown in FIG. 7 an imaging system 70 including an imaging device 72 such as an MRA or CTA system coupled to a computing platform 74. In this embodiment, the imaging device is used to obtain the arterial and venous phase image data as variously referred to above, and the computing platform is used to execute all or a portion of the computer programs described above. In one such embodiment, system 70 is used to perform one or more of the steps of the described methods or execute one or more portions of the described computer code, while others of the steps or code portions are performed or executed on a different other computing platform. For example, the VOXAR Plug n View system, available from VOXAR, Inc., of San Antonia, Tex., may be used as the other computing platform, while the imaging device may comprise a MRA or CTA device available from Phillips, Inc. or Seimens, Inc.

### CONCLUSION

Thus there has been described above various embodiments of the invention useful to obtain images of the vascular system, wherein the arteries and veins can be seen with a desired level of clarity, and blood flow may also be studied.

What is claimed is:

1. A method, comprising:
obtaining baseline phase image data of a body part without a contrast agent in the vessels;
obtaining arterial phase image data of a body part with a contrast agent in the arterial vessels but substantially not in the venous vessels;
obtaining venous phase image data of the body part with the contrast agent in both the arterial vessels and the venous vessels;
isolating arterial image data from the arterial phase image data and the baseline phase image data;
isolating venous image data from the arterial phase image data and the venous phase image data.

2. A method according to claim 1, including:
altering one or both of the isolated arterial image data and the isolated venous image data to produce altered arterial image data and/or altered venous image data; and
displaying images derived from the altered arterial image data and or altered venous image data superimposed on one another.

3. A method according to claim 1 further including altering the isolated arterial image data or the isolated venous image data by adjusting the opacity of the image.

4. A method according to claim 1 further including altering the isolated arterial image data or the isolated venous image data by adjusting the brightness of the image.

5. A method according to claim 1 further including the altering of one or both of the image data is performed while the derived images are displayed.

6. A method according to claim 1 further including alternately displaying only one of the derived images at a time instead of displaying the derived images superimposed on each other.

7. A method according to claim 1 further including altering the isolated arterial image data or the isolated venous image data so that the corresponding arteries and veins are displayed in one or more different colors.

8. A method according to claim 7 further wherein the arteries are colored red and veins are colored blue.

9. A method, comprising:
obtaining baseline phase image data of a body part of a patient without a contrast agent in the vessels;
obtaining arterial phase image data of the body part with a contrast agent in the arterial vessels but substantially not in the venous vessels;
obtaining venous phase image data of the body part with the contrast agent in both the arterial vessels and the venous vessels;
producing isolated arterial image data by subtracting baseline phase image data from the arterial phase image data;
producing isolated venous image data by subtracting arterial phase image data from the venous phase image data;
altering the isolated arterial image data and/or the isolated venous image data to produce altered arterial image data and/or altered venous image data;
displaying the altered arterial image data and or altered venous image data superimposed on one another.

10. A method, comprising:
obtaining one or more sets of arterial phase image data of the body part with a contrast agent in the arterial vessels but substantially not in the venous vessels;
obtaining one or more sets of venous phase image data of the body part with the contrast agent in both the arterial vessels and the venous vessels;
isolating arterial image data and venous image data from the one or more sets of arterial phase image data and/or the venous phase image data;
altering one or both of the isolated arterial image data sets and the isolated venous image data sets to produce altered arterial image data and/or altered venous image data sets wherein each set in the sequence of acquired data sets is altered so that the color of each sequential image is different;
displaying images derived from the altered arterial image or venous image data sets in a sequence to illustrate blood flow.

11. An article of manufacture comprising a computer program stored on or in a storage medium, comprising:
computer code for storing and retrieving baseline phase image data, arterial phase image data and venous phase image data, wherein the arterial phase image data is obtained from a body part with a contrast agent in the arterial vessels but substantially not in the venous vessels, and the venous phase image data is obtained from a body part with the contrast agent in both the arterial vessels and the venous vessels;
computer code for isolating arterial image data and venous image data from the baseline phase image data, arterial phase image data and/or the venous phase image data.

12. An article of manufacture according to claim 11, including:
computer code for altering one or both of the isolated arterial image data and the isolated venous image data to produce altered arterial image data and/or altered venous image data; and
computer code for displaying images derived from the altered arterial image data and or altered venous image data superimposed on one another.

13. Computer code according to claim 12 further including code for altering the isolated arterial image data or the isolated venous image data by adjusting the opacity of the image.

14. Computer code according to claim 12 further including code for altering the isolated arterial image data or the isolated venous image data by adjusting the brightness of the image.

15. Computer code according to claim 12 further including code for the altering of one or both of the image data is performed while the derived images are displayed.

16. Computer code according to claim 12 further including code for alternately displaying only one of the derived images at a time instead of displaying the derived images superimposed on each other.

17. Computer code according to claim 12 further including code for altering the isolated arterial image data or the isolated venous image data so that the corresponding arteries and veins are displayed in one or more different colors.

18. Computer code according to claim 17 further including code for coloring the arteries red and the veins blue.

19. An article of manufacture comprising a computer program stored on or in a storage medium, comprising:
computer code for storing and retrieving baseline phase image data of a body part of a patient without a contrast agent in the vessels;
computer code for storing and retrieving arterial phase image data and venous phase image data, wherein the arterial phase image data is obtained from a body part with a contrast agent in the arterial vessels but substantially not in the venous vessels, and the venous phase image data is obtained from a body part with the contrast agent in both the arterial vessels and the venous vessels;
computer code for producing isolated arterial image data by subtracting baseline phase image data from the arterial phase image data;
computer code for producing isolated venous image data by subtracting arterial phase image data from the venous phase image data;
computer code for altering the isolated arterial image data and/or the isolated venous image data to produce altered arterial image data and/or altered venous image data;
computer code for displaying the altered arterial image data and or altered venous image data superimposed on one another.

20. An article of manufacture comprising a computer program stored on or in a storage medium, comprising:
computer code for storing and retrieving one or more sets of arterial phase image data of the body part with a contrast agent in the arterial vessels but substantially not in the venous vessels;
computer code for storing and retrieving one or more sets of venous phase image data of the body part with the contrast agent in both the arterial vessels and the venous vessels;
computer code for isolating arterial image data and venous image data from the one or more sets of arterial phase image data and/or the venous phase image data;
computer code for altering one or both of the isolated arterial image data sets and the isolated venous image data sets to produce altered arterial image data and/or altered venous image data sets wherein each set in the sequence of acquired data sets is altered so that the color of each sequential image is different;
computer code for displaying images derived from the altered arterial image or venous image data sets in a sequence to illustrate blood flow.

21. A systems, comprising:
an imaging system for obtaining arterial phase image data of a body part with a contrast agent in the arterial vessels but substantially not in the venous vessels, and for obtaining venous phase image data of the body part with the contrast agent in both the arterial vessels and the venous vessels;
the imaging system including program code for isolating arterial image data and venous image data from the arterial phase image data and/or the venous phase image data;
the imaging system further including program code for altering one or both of the isolated arterial image data and the isolated venous image data to produce altered arterial image data and/or altered venous image data;
the imaging systems further including program code for displaying images derived from the altered arterial image data and or altered venous image data superimposed on one another.
